(19) United States
(12) Patent Application Publication
(10) Pub. No.: US 2007/0154698 A1
(43) Pub. Date: Jul. 5, 2007

(54) HIGHLY FLEXIBLE AEROGEL INSULATED TEXTILE-LIKE BLANKETS

(75) Inventor: Christopher J. Stepanian, Somerville, MA (US)

Correspondence Address: ASPEN AEROGELS INC.;IP DEPARTMENT, 30 FORBES ROAD, BLDG. B, NORTHBOROUGH, MA, 01532, US

(73) Assignee: Aspen Aerogels, Inc., Northborough, MA (US)

(21) Appl. No.: 11/619,022

(22) Filed: Jan. 2, 2007

Related U.S. Application Data
(60) Provisional application No. 60/755,119, filed on Dec. 30, 2005.

(51) Int. Cl. B32B 13/02; B32B 9/04

(52) U.S. Cl. 428/294.7; 428/446

(57) ABSTRACT

Embodiments of the present invention describe flexible and moisture permeable structures comprising fiber-reinforced aerogels. Such structures comprise hole-punched and/or strips of fiber-reinforced aerogels.

### CROSS-REFERENCES TO RELATED APPLICATIONS

This application claims benefit of priority from U.S. Provisional Patent Application 60/755,119, filed Dec. 30, 2005. The previous application is hereby incorporated by reference in their entireties as if fully set forth.

### FIELD OF THE INVENTION

This invention relates generally to insulated textile-like material and more particularly to aerogel based textile like highly flexible material and various methods of preparing such material.

### SUMMARY OF THE INVENTION

Embodiments of the present invention describe flexible and moisture permeable insulating structures comprising fiber-reinforced aerogels. Such structures comprise hole-punched and/or strips of fiber-reinforced aerogels.

### DESCRIPTION

The thermal comfort provided by apparel or a protective object like an outdoor tent, is typically dependent on the insulating layer therein. Such dependency is even more pronounced when the protective object is designed for extreme conditions, like that of arctic climates. In addition to thermal performance, the insulating layer may also be required to show: mechanical performance (compression strength, recovery, etc.), moisture permeability, low density, durability, low thickness, easy handling (flexible, low/no dusting) and manipulability (laminate-able etc.) Moisture permeability (i.e. breathability) and flexibility of the insulation layer are of particular concern for certain protective objects, such as jackets, gloves, sleeping bags, tents etc. Such properties may also be useful in various applications including building & construction, and industrial insulation. For instance work jackets for arctic climates (or furnace-related environments) require high insulation yet the worker must be able to maneuver with minimal hindrance. Furthermore, without moisture permeation, active apparel quickly become uncomfortable due to the excessive vapor build up. Aerogels can be highly useful for insulating apparel given their low density, low thermal conductivity, flexible composite forms and various other useful properties Embodiments of the present invention describe specially designed structures comprising aerogel composites that exhibit enhanced flexibility and moisture permeability. These insulating structures are applicable to any thermal or acoustic insulation applications. Preferably, said structures are applicable to any article of clothing or protective objects where insulation is of interest including but not limited to: jackets, vests, headwear, footwear (insoles, uppers, etc.), gloves, socks, leggings, neck gaiter, hats, tents, sleeping bags, blankets etc. The properties of the structures of the present invention such as water vapor permeability, acoustic transmission etc. may also find use in building insulation including insulation for building envelopes.

Within the context of embodiments of the present invention “aerogels” or “aerogel materials” along with their respective singular forms, refer to gels containing air as a dispersion medium in a broad sense, and include aerogels, xerogels and cryogels in a narrow sense. Furthermore, the chemical composition of aerogels can be inorganic, organic (including polymers) or hybrid organic-inorganic. Still further, aerogels can be opacified with compounds such as but not limited to: B₄C, Diatomite, Manganese ferrite, MnO , NiO , SnO , Ag₂O , Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof. The aforementioned fiber-reinforced aerogels can be reinforced via polymer-based fibers (e.g. polyester) or inorganic fibers (e.g. carbon, quartz, etc.) or both, wherein the fibers are in forms such as: a batting (e.g. lofty form), mats, felts, microfibers, chopped fibers or a combination thereof.

Examples of inorganic aerogels include, but are not limited to silica, titania, zirconia, alumina, hafnia, yttria and ceria. Organic aerogels can be based on, but are not limited to, compounds such as, urethanes, resorcinol formaldehydes, polyimide, polyacrylates , chitosan, polymethyl methacrylate, members of the acrylate family of oligomers, trialkoxysilylterminated polydimethylsiloxane, polyoxyalkylene, polyurethane, polybutadiane, melanime-formaldehyde, phenol-furfural, a member of the polyether family of materials or combinations thereof. Of course carbon aerogels are also of interest. Examples of organic-inorganic hybrid aerogels are, but not limited to, silica-PMMA, silica-chitosan, silica-polyether or possibly a combination of the aforementioned organic and inorganic compounds. Published US patent applications 2005/0192367 and 2005/0192366 teach exclusively of such hybrid organic-inorganic materials and are hereby incorporated by reference in their entirety.

Aerogel composites reinforced with a fibrous batting, herein referred to as “blankets”, are particularly useful for applications requiring flexibility since they are conformable and provide excellent thermal conductivity. Aerogel blankets and similar fiber-reinforced aerogel composites are described in published US patent application 2002/0094426A1 and U.S. Pat. Nos. 6,068,882, 5,789,075, 5,306,555, 6,887,563, and 6,080,475, all hereby incorporated by reference, in their entirety. In an exemplary manner and without an implied limitation, embodiments of the present invention utilize aerogel blankets, though analogous aerogel composites (e.g. those disclosed by reference) may also be similarly utilized.

In one embodiment of the present invention the aerogel blankets are designed with through holes therein, thereby allowing for moisture to escape more readily while simultaneously adding to the overall flexibility. In another embodiment, small but engineered tears, indentations or openings may be designed in the aerogel blankets that provide for more flexibility than without such tears or openings. It is noted here that a particular commercial model aerogel blanket in itself may be flexible. However, what the embodiments of the present invention provide are ways to make it more flexible or allow for addition of ingredients that may make the aerogel blanket more rigid and use the embodiments to make it further flexible. Such ingredients may allow other specific properties for example better fire resistance, smoke suppression or similar properties. Use of the flexibility enhancing embodiments provide for the ability to combine flexibility and specific performance.

In yet another embodiment, strips or pockets of aerogel blanket are encapsulated in a fabric or membrane and sewn to have pockets or pouches. i.e stitches are made around a piece of aerogel in a defined fashion like in a rectangular fashion. Such stitches make the aerogel hold in place within the encapsulating membrane or bag and also allow for the whole encapsulated aerogel blanket to be folded or made flexible along the stitched seams. The pattern in which the stitches are made may be varied and optimized for flexibility in uni, bi or omni direction.

In an embodiment, individual strips (of any arbitrary shape) of fiber-reinforced aerogels interlaced or otherwise interlocked provide mobile individual components within the insulating structure thereby enhancing overall flexibility. On the other hand, creating holes, tears, openings, within a blanket serves to add to flexibility since many regions of the blanket can compress more readily into the holes during flexure.

### DESCRIPTION OF FIGURES

FIG. 1 illustrates a method of preparing fiber-reinforced aerogel composites.

FIG. 2 is a perspective and cross-sectional view of an arrangement of aerogel blanket strips in accordance with an embodiment of the present invention.

FIG. 3 is a perspective and cross-sectional view of another arrangement of aerogel blanket strips in accordance with another embodiment of the present invention.

FIG. 4 is a perspective view of an aerogel blanket with an arrangement of through holes.

FIG. 5 is a cross-sectional view of a multiple lay up of aerogel blanket strips.

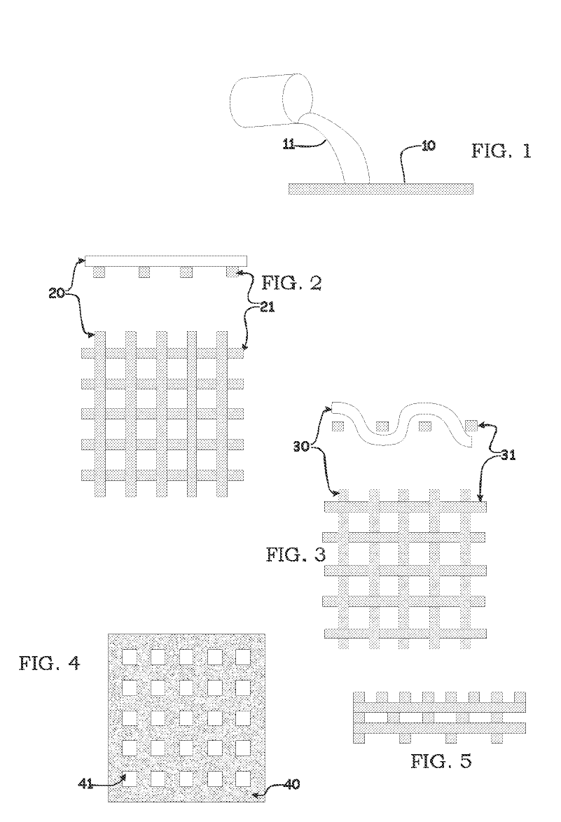

### DETAILED DESCRIPTION

Fiber-reinforced aerogel composites can be formed by pouring a pre-gel mixture comprising a gel precursor into a fibrous matrix 11, wherein the mixture subsequently gels resulting in a gel composite. Subsequently the gel composite is dried to form a fiber reinforced aerogel composite (e.g. aerogel blanket). Alternatively, the aerogel composite may be prepared by adding fibers, or a fibrous matrix, to a pre-gel mixture comprising gel precursors followed by drying as described.

Drying may be accomplished using a variety of methods known in the art. U.S. Pat. No. 6,670,402 teaches drying via rapid solvent exchange of solvent inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby Resorcinol/Formaldehyde aerogels can be manufactured using a simple air drying procedure. Finally, U.S. Pat. No. 5,565,142 describes drying techniques at vacuum to below super-critical pressures using surface modifying agents.

The fiber-reinforced aerogel composites (e.g. aerogel blankets) may be prepared or cut into strips of desired width and length; hole-punched or otherwise perforated with desired puncture sizes and densities or a combination thereof. The strips may be arranged, or hole-punched so as to result in voids that are large enough to accommodate for desired moisture permeation rates. As exemplified in FIG. 2, a first layer comprising a spaced arrangement of first aerogel blanket strips 21 is superposed with a second layer comprising a spaced arrangement of second aerogel blanket strips 20 yielding a perforated structure. Alternatively, as exemplified in FIG. 3, a first layer comprising a spaced arrangement of first aerogel blanket strips 31 is interwoven with a second layer comprising a spaced arrangement of second aerogel blanket strips 30 yielding again a perforated structure. In yet another alternative method exemplified by FIG. 4, an aerogel blanket 40 is punched with holes 41 completely penetrating said aerogel blanket to achieve a perforated structure. Alternatively, aerogel strips of any arbitrary shape 41 may be attached to a planar substrate 40 and used in the embodiments of the present invention.

It is noted here that the illustrated figures are not necessarily to scale or the elements of the figures are not necessarily proportional. However, it is possible and more appropriate to have smaller openings or gaps between two adjacent strips of aerogels compared to the size of the strips themselves. Proportionality shown in the figures are not limiting the scope of the disclosure.

In some embodiments aerogel blanket strips are arranged in a multiple layer structure such that each layer comprises a plurality of aerogel blanket strips, arranged in a substantially parallel manner and wherein at least some strips are not in contact with any other (within the same layer.) Said multiple-layer structure comprises at least two plies, each layer comprising a plurality of strips such that the general directions of the strips within a layer are non-parallel with respect to that of adjacent plies (or layer.) In a non-limiting example, strips in adjacent plies are arranged in an angle of between about 45 degrees and 90 degrees with respect to one another.

In some embodiments aerogel blanket strips are arranged in a multiple-layer structure such that each layer comprises a plurality of aerogel blanket strips, arranged in a substantially parallel manner and wherein at least some strips in adjacent plies are mutually interlaced. The mutually interlaced arrangement may resemble a woven form, a braided form or any other form of textile. Said multiple-layer structure comprises at least two plies, each layer comprising a plurality of strips such that the general directions of the strips within a layer are non-parallel with respect to that of adjacent plies (or layer.) In a non-limiting example, strips in adjacent plies are arranged in an angle of between about 45 degrees and 90 degrees with respect to one another.

In some embodiments aerogel blankets are hole-punched, die cut, indented or torn or otherwise perforated with a plurality holes, openings, cuts, indentations or gaps. At least some of the holes should preferably penetrate the aerogel blanket completely such that moisture or other vapors may pass through more easily. The cross section of the holes may be of any shape such as triangular, square, circular or combinations thereof and with diameters of at least about 0.1 mm. Accordingly a multiple-layer arrangement comprising at least two plies of hole-punched blankets may be constructed such that at least some, or none of the holes line-up.

In some embodiments, aerogel plies are secured to one another via tags, stitches, rivets, staples, adhesives, needle-punching or any combination thereof. This may be equally achieved in structures comprising strips or structures that are hole-punched.

In one embodiment, the holes in the multiple-layer structure are filled with a fibrous material such as a batting. This may be carried out to minimize thermal conductivity gain in structures where the holes are substantially large in diameter.

In one embodiment a fibrous layer is placed between adjacent blankets, or strips. Said fibrous layer thereby “plugging” the holes created to a degree such that thermal conductivity of the overall structure is improved while moisture permeability is minimally reduced. Low density fibrous materials and lofty fibrous forms are one such example.

In some embodiments, diameter of holes in the insulated structures presently described, are designed such that the overall structure provides some level of acoustic damping. Given that sound travels via propagation of air molecules, movement of air through (or simply into) the holes of said structures (rather than only reflecting) may provide a desired level of acoustic damping. The inclusion of fibrous batting in the holes may have an additional positive effect on the ability of the structure to absorb and/or reflect acoustic energy. In an embodiment, a layer or multiple layers of batting may be interposed between the strips or perforated aerogel blankets.

In some embodiments, the size of holes within each layer is at least about 0.1 mm, at least about 0.5 mm, least about 1 mm, least about 2 mm, least about 5 mm, least about 10 mm or least about 20 mm in diameter. The average density of holes within a layer may be at least 1000/cm², at least 500/cm², at least 100/cm², at least 50/cm², at least 10/cm², at least 5/cm², at least 1/cm², at least 0.1/cm² or at least 0.01/cm² wherein the distribution thereof may be uniform or non-uniform throughout the layer.

In one embodiment the aerogel blankets layers (or blanket strips) or a structure comprising the same is encased hermetically (or non-hermetically) in a polymeric material such as but not limited to: polyesters, polyethylenes, polypropylenes, fabrics or similar material. This allows for a) reduced pressure environments for the aerogel material thereby achieving lower a thermal conductivity yet, or b) containment of any potential dusting (flaking) from the aerogel or c) a slip layer for the insulation and other potential uses or combinations of a, b and c. A slip layer aids in relative motion of the blanket layers and/or blanket strips. In some cases it is desirable to use moisture permeable polymeric materials such as Tyvek®.

In one embodiment the aerogels are coated with a polymeric material. This may be carried out to reduce free particulate matter on the surface of the aerogel material, provide an abrasion resistant surface, provide a slip layer, or other reasons. The coating may be applied by spraying, lamination or other techniques known in the art. Suitable coatings include but are not limited to: acrylic coatings, silicone-containing coatings, phenolic coatings, vinyl acetate coatings, ethylene-vinyl acetate coatings, styrene-acrylate coatings, styrene-butadiene coatings, polyvinyl alcohol coatings, polyvinyl-chloride coatings, acrylamide coatings, copolymers or combinations thereof. The coatings may be further subject to a heat treatment step, cross-linking agents, or both. The coating may be applied either before the aerogel is cut into strips or perforated with a plurality of holes or after these materials have been cut into strips or perforated with a plurality of holes. The coating may also be applied after the strips or perforated blanket have been plied together to form a substructure or structure.

In another embodiment the aerogel blanket layers or a structure comprising the same as described in the present description, is incorporated into and article of clothing such as but not limited to: jackets, vests, headwear, footwear (toe caps, heels, insoles, uppers, etc.), gloves, socks, leggings, neck gaiter, tents, sleeping bags and hats. The insulating structure may be encased in a polymeric film.

In another embodiment, the insulation structure of the present invention exhibit a water vapor permeability of greater than about 1 g/m2/day, preferably greater than about 10 g/m2/day, more preferably greater than about 100 g/m2/day and most preferably greater than about 1000 g/m2/day.

The figures, descriptions thereof and embodiments presented herein are merely presented to better illustrate aspects of the present invention and therefore should not be construed as limitations on the scope or spirit of the invention as a whole.

What is claimed is:

1. A structure comprising at least two superposed layers, wherein at least one of said two layers is an insulating layer comprising a plurality of fiber-reinforced aerogel strips.

2. The structure of claim 1 wherein the aerogel is reinforced with a fibrous batting.

3. The structure of claim 1 wherein the strips are arranged in a substantially parallel manner.

4. The structure of claim 3, further comprising a plurality of holes, tears, cuts, openings, indentations or combinations thereof.

5. The structure of claim 3 wherein at least some of said aerogel strips are interwoven.

6. The structure of claim 1 wherein said layers are secured to one another via tags, stitches, staples, adhesives, needle-punching or a combination thereof.

7. The structure of claim 5 further comprising a plurality of holes, tears, cuts, openings, indentations or combinations thereof.

8. The structure of claim 7 wherein said holes, tears, cuts, openings or indentations are at least partially covered or filled with a fibrous structure.

9. A structure comprising at least one layer of fiber-reinforced aerogel wherein said layer comprises a plurality of holes, tears, cuts, openings, indentations or combinations thereof.

10. The structure of claim 9 wherein the density of the holes tears, cuts, openings, indentations or combinations thereof is between about 1000/cm² to 0.01/cm².

11. The structure of claim 9 wherein said holes, tears, cuts, openings or indentations are at least partially covered by a fibrous structure.

12. A method of forming an insulating structure comprising providing at least two superposed layers, wherein at least one of said layers is an insulating layer comprising a plurality of fiber-reinforced aerogel strips.

13. The method of claim 12 wherein the strips are arranged in a substantially parallel

14. The method of claim 12 wherein at least some of the aerogel strips of adjacent layers are interwoven.

15. The method of claim 12 wherein said layers are secured to one another via tags, stitches, staples, adhesives, needle-punching or a combination thereof.

16. A method of forming an insulating structure comprising providing least one fiber-reinforced aerogel layer comprising a plurality of holes, tears, cuts, openings, indentations or combinations thereof.

17. The method of claim 16 wherein the density of the holes tears, cuts, openings, indentations or combinations thereof is between about 1000/cm² to 0.01/cm².

18. The method of claim 16 wherein said holes, tears, cuts, openings or indentations are at least partially covered by a fibrous structure.

19. A sound reflecting, transmitting or dampening structure comprising the structure of claim 1.

20. A sound reflecting, transmitting or dampening structure comprising the structure of claim 9.
